(19) United States
(12) Patent Application Publication
(10) Pub. No.: US 2024/0018291 A1
(43) Pub. Date: Jan. 18, 2024

(54) CURABLE POLYURETHANE RESIN COMPOSITION, CURED OBJECT, AND LAYERED PRODUCT

(71) Applicant: MITSUI CHEMICALS, INC., Tokyo (JP)

(72) Inventor: Yohsuke ASANO, Chiba-shi, Chiba (JP)

(21) Appl. No.: 18/272,518

(22) PCT Filed: Mar. 22, 2022
(86) PCT No.: PCT/JP2022/013214

§ 371 Date: Jul. 14, 2023

(30) Foreign Application Priority Data
Mar. 29, 2021 (JP) 2021-055942

(51) Int. Cl. C08G 18/10; C08G 18/73; C08G 18/44; C08G 18/34

(52) U.S. Cl. CPC C08G 18/10; C08G 18/73; C08G 18/44; C08G 18/343

(57) ABSTRACT

A curable polyurethane resin composition contains a polyisocyanate component containing an aliphatic diisocyanate and/or a derivative thereof, and a hydroxyl component containing a heterocyclic ring-containing plant-derived polyol that contains a heterocyclic structure and is derived from plants; and a hydroxyl group-containing unsaturated compound containing an ethylenically unsaturated group and a hydroxyl group.

### TECHNICAL FIELD

The present invention relates to a curable polyurethane resin composition, a cured product, and a laminate, and more particularly to a curable polyurethane resin composition that is cured by irradiation with an active energy ray, a cured product thereof, and a laminate including a cured film made of the cured product.

### BACKGROUND ART

Urethane acrylate is used in a wide range of fields such as various industrial products including coating materials, inks, pressure-sensitive adhesives, adhesives, and the like.

In recent years, there has been studied that plant-derived raw materials are used in such urethane acrylate in order to reduce environmental load.

There has been proposed, for example, a curable polyurethane resin composition containing a urethane resin obtained by allowing a polyisocyanate containing plant-derived pentamethylene diisocyanate and/or a derivative thereof to react with a polyol and a hydroxyl group-containing unsaturated compound containing an ethylenically unsaturated group and a hydroxyl group (cf. Patent Document 1).

### CITATION LIST

### Patent Document

Patent Document 1: Japanese Unexamined Patent Publication No. 2016-190948

### SUMMARY OF THE INVENTION

### Problem to be Solved by the Invention

In Patent Document 1, a polyfunctional (meth)acrylate is further blended with the curable polyurethane resin composition, and the blended mixture is then irradiated with an active energy ray to crosslink the urethane resin, thereby obtaining a cured product.

However, in the curable polyurethane resin composition, when the polyfunctional (meth)acrylate is blended with the curable polyurethane resin composition, compatibility of the polyfunctional (meth)acrylate with the urethane resin is not sufficient depending on the type of polyol, which may cause cloudiness in the cured product thus obtained.

The present invention provides a curable polyurethane resin composition capable of suppressing cloudiness, a cured product thereof, and a laminate including a cured film made of the cured product.

### Means for Solving the Problem

The present invention [1] includes a curable polyurethane resin composition containing a reaction product of a polyisocyanate component containing an aliphatic diisocyanate and/or a derivative thereof, and a hydroxyl component containing a heterocyclic ring-containing plant-derived polyol that contains a heterocyclic structure and is derived from plants; and a hydroxyl group-containing unsaturated compound containing an ethylenically unsaturated group and a hydroxyl group.

The present invention [2] includes the curable polyurethane resin composition described in [1], in which the aliphatic diisocyanate contains plant-derived 1,5-pentamethyl ene diisocyanate.

The present invention [3] includes the curable polyurethane resin composition described in [1] or [2], in which the heterocyclic ring-containing plant-derived polyol is an isosorbide-modified polycarbonate polyol.

The present invention [4] includes the curable polyurethane resin composition described in any one of [1] to [3], further including a polyfunctional (meth)acrylate having three or more ethylenically unsaturated groups, in which the polyfunctional (meth)acrylate is contained in an amount of 30 parts by mass or more relative to 100 parts by mass of the reaction product.

The present invention [5] includes a cured product of the curable polyurethane resin composition described in any one of [1] to [4].

The present invention [6] includes the cured product described in [5], having a haze of less than 0.5%.

The present invention [7] includes a laminate, including an object to be coated; and a cured film made of the cured product described in [5] or [6] in a thickness direction.

### Effects of the Invention

The curable polyurethane resin composition of the present invention contains, as a polyol, a heterocyclic ring-containing plant-derived polyol that contains a heterocyclic structure and is derived from plants. Therefore, cloudiness in the cured product obtained by curing the curable polyurethane resin composition can be suppressed while environmental load is reduced. As a result, the cured product of the present invention and the laminate of the present invention including a cured film made of the cured product can suppress cloudiness in the cured film while reducing environmental load.

### BRIEF DESCRIPTION OF THE DRAWINGS

FIGS. 1A and 1B are schematic views showing an embodiment of a method for producing a laminate according to the present invention: FIG. 1A shows a first step of preparing an object to be coated, and FIG. 1B shows a second step of disposing a cured film on one surface in the thickness direction of the object to be coated.

### DESCRIPTION OF THE EMBODIMENTS

The curable polyurethane resin composition of the present invention contains a reaction product of a polyisocyanate component and a hydroxyl component. The reaction product is a urethane resin. More specifically, the hydroxyl component contains a hydroxyl group-containing unsaturated compound, so that the reaction product is an active energy ray-curable urethane resin.

### <Polyisocyanate Component>

The polyisocyanate component contains an aliphatic diisocyanate and/or a derivative thereof.

Examples of the aliphatic diisocyanate include hexamethylene diisocyanate (hexane diisocyanate) (HDI), pentamethylene diisocyanate (pentane diisocyanate) (PDI), tetramethylene diisocyanate, trimethylene diisocyanate, 1,2-, 2,3-, or 1,3-butylene diisocyanate, and 2,4,4- or 2,2,4-trimethylhexamethylene diisocyanate.

Examples of the hexamethylene diisocyanate include 1,2-hexamethylene diisocyanate, 1,3-hexamethylene diisocyanate, 1,4-hexamethylene diisocyanate, 1,5-hexamethylene diisocyanate, 1,6-hexamethylene diisocyanate, and 2,5-hexamethylene diisocyanate, and preferably, 1,6-hexamethylene diisocyanate is used.

Examples of the pentamethylene diisocyanate include 1,5-pentamethylene diisocyanate, 1,4-pentamethylene diisocyanate, and 1,3-pentamethylene diisocyanate, and preferably, 1,5-pentamethylene diisocyanate is used.

For the aliphatic diisocyanate, preferably, hexamethylene diisocyanate and pentamethylene diisocyanate are used, more preferably, pentamethylene diisocyanate is used, further preferably, 1,5-pentamethylene diisocyanate is used.

1,5-Pentamethylene diisocyanate is particularly preferably derived from plants. The plant-derived 1,5-pentamethylene diisocyanate can be obtained by enzymatic decarboxylation reaction of lysine. A method for producing the plant-derived 1,5-pentamethylene diisocyanate is described in International Publication No. WO2012/121291.

The 1,5-pentamethylene diisocyanate has a degree of biomass of, for example, 10% or more, preferably 50% or more, more preferably 60% or more, further preferably 65% or more, and for example, 80% or less.

A method for calculating the degree of biomass is described in detail in Examples to be described later (the same applies hereinafter).

The aliphatic diisocyanates can be used alone or in combination of two or more.

Examples of the derivative of the aliphatic diisocyanate include multimers (e.g., dimers, trimers (e.g., isocyanurate derivatives, iminooxadiazinedione derivatives), pentamers, heptamers, etc.) of the above-described aliphatic diisocyanate, allophanate derivatives (e.g., an allophanate derivative produced by reaction of the above-described aliphatic diisocyanate with monohydric alcohol or dihydric alcohol), polyol derivatives (e.g., a polyol derivative (alcohol adduct) produced by reaction of the above-described aliphatic diisocyanate with trihydric alcohol (e.g., trimethylolpropane), etc.), biuret derivatives (e.g., a biuret derivative produced by reaction of the above-described aliphatic diisocyanate with water or amines, etc.), urea derivatives (e.g., a urea derivative produced by reaction of the above-described aliphatic diisocyanate with diamine, etc.), oxadiazinetrione derivatives (e.g., an oxadiazinetrione derivative produced by reaction of the above-described aliphatic diisocyanate with carbon dioxide, etc.), carbodiimide derivatives (e.g., a carbodiimide derivative produced by decarboxylation condensation reaction of the above-described aliphatic diisocyanate, etc.), uretdione derivatives, and uretonimine derivatives. Preferably, an isocyanurate derivative is used, more preferably, an isocyanurate derivative of pentamethylene diisocyanate is used, further preferably, an isocyanurate derivative of 1,5-pentamethylene diisocyanate is used, particularly preferably, an isocyanurate derivative of plant-derived 1,5-pentamethylene diisocyanate is used.

The isocyanurate derivative of the plant-derived 1,5-pentamethylene diisocyanate has a degree of biomass of, for example, 10% or more, preferably 50% or more, more preferably 60% or more, further preferably 65% or more, and for example, 80% or less.

The derivatives of the aliphatic diisocyanate can be used alone or in combination of two or more.

The polyisocyanate component can further contain other polyisocyanates and/or derivatives thereof.

Examples of other polyisocyanates include aromatic diisocyanate, araliphatic diisocyanate, and alicyclic diisocyanate.

Examples of the aromatic diisocyanate include 4,4′-, 2,4′-, or 2,2′-diphenylmethane diisocyanate or a mixture thereof (MDI), 2,4′- or 2,6′-tolylene diisocyanate or a mixture thereof (TDI), o-tolidine diisocyanate, 1,5-naphthalene diisocyanate (NDI), m- or p-phenylene diisocyanate or a mixture thereof, 4,4′-diphenyl diisocyanate, and 4,4′-diphenylether diisocyanate.

Examples of the araliphatic diisocyanate include xylylene diisocyanate (1,2-, 1,3-, or 1,4-xylylene diisocyanate or a mixture thereof) (XDI), 1,3- or 1,4-tetramethylxylylene diisocyanate or a mixture thereof (TMXDI), and ω,ω′-diisocyanate-1,4-diethylbenzene.

Examples of the alicyclic diisocyanate include 3-isocyanatomethyl-3,5,5-trimethylcyclohexylisocyanate (isophorone diisocyanate, IPDI), 4,4′-, 2,4′- or 2,2′-methylenebis(cyclohexylisocyanate) or a mixture thereof (HINDI), 1,3- or 1,4-bis(isocyanatomethyl)cyclohexane or a mixture thereof (H₆XDI), bis(isocyanatomethyl)norbornane (NBDI), 1,3-cyclopentene diisocyanate, 1,4-cyclohexane diisocyanate, 1,3-cyclohexane diisocyanate, methyl-2,4-cyclohexane diisocyanate, and methyl-2,6-cyclohexane diisocyanate.

For the derivatives of other polyisocyanates, those described as the derivative of the aliphatic diisocyanate are used.

Such other polyisocyanates and derivatives thereof are blended in an amount of, for example, 1 part by mass or more, preferably 5 parts by mass or more, and for example, 20 parts by mass or less relative to 100 parts by mass of the polyisocyanate component.

Other polyisocyanates and derivatives thereof can be used alone or in combination of two or more.

The polyisocyanate component preferably contains aliphatic diisocyanate and/or a derivative thereof but not contain other polyisocyanates and derivatives thereof, more preferably does not contain a derivative of aliphatic diisocyanate but contains aliphatic diisocyanate or contains aliphatic diisocyanate and a derivative thereof.

When the polyisocyanate component contains aliphatic diisocyanate and a derivative thereof, the aliphatic diisocyanate is contained in an amount of, for example, 60 parts by mass or more, preferably 70 parts by mass or more, more preferably 80 parts by mass or more, and for example, 90 parts by mass or less relative to 100 parts by mass of the aliphatic diisocyanate and its derivative. Further, the derivative of the aliphatic diisocyanate is contained in an amount of, for example, 10 parts by mass or more, and for example, 40 parts by mass or less, preferably 30 parts by mass or less, more preferably 20 parts by mass or less.

The polyisocyanate component particularly preferably does not contain a derivative of aliphatic diisocyanate but contains aliphatic diisocyanate. This can further suppress cloudiness in the cured product obtained by curing the curable polyurethane resin composition.

### <Hydroxyl Component>

The hydroxyl component contains a heterocyclic ring-containing plant-derived polyol and a hydroxyl group-containing unsaturated compound.

### [Heterocyclic Ring-Containing Plant-Derived Polyol]

The heterocyclic ring-containing plant-derived polyol is a plant-derived polyol having one or more heterocyclic rings in its molecule.

Examples of this heterocyclic ring-containing plant-derived polyol include polyols containing a constituent unit derived from a dihydroxy compound represented by the following formula (1).

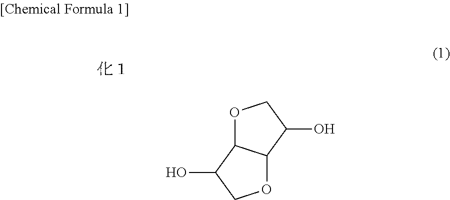

Examples of the dihydroxy compound represented by the formula (1) above include isoorbide, isomannide, and isoidet as structural isomers, and preferably, isoorbide is used.

The dihydroxy compound represented by the formula (1) above is a component derived from plants.

The polyol can further contain constituent units derived from other dihydroxy compounds.

Examples of the constituent units derived from other dihydroxy compounds include a constituent unit derived from an aliphatic dihydroxy compound, and a constituent unit derived from an alicyclic dihydroxy compound (except the constituent unit derived from the dihydroxy compound represented by the formula (1) above; the same applies hereinafter).

Examples of the aliphatic dihydroxy compound include a linear aliphatic dihydroxy compound and a branched aliphatic dihydroxy compound. Examples of the linear aliphatic dihydroxy compound include ethylene glycol, 1,3-propanediol, 1,4-butylene glycol, 1,5-pentanediol, 1,6-hexanediol, 1,7-heptanediol, 1,8-octanediol, 1,9-nonanediol, 1,10-decanediol, 1,11-undecanediol, and 1,12-dodecanediol. Examples of the branched aliphatic dihydroxy compound include 1,2-propanediol, 1,3-butanediol, 1,2-butanediol, neopentyl glycol, and hexylene glycol.

Examples of the alicyclic dihydroxy compound include 1,2-cyclohexane dimethanol, 1,3-cyclohexane dimethanol, 1,4-cyclohexane dimethanol, tricyclodecane dimethanol, pentacyclopentadecane dimethanol, 2,6-decalin dimethanol, 1,5-decalin dimethanol, 2,3-decalin dimethanol, 2,3-norbornane dimethanol, 2,5-norbornane dimethanol, and 1,3-adamantane dimethanol.

In the polyol containing the constituent unit derived from the dihydroxy compound represented by the formula (1) above, the polyol is preferably a macropolyol.

The macropolyol is a high-molecular-weight polyol having a number average molecular weight of 250 or more, preferably 400 or more, and for example, 10000 or less.

Examples of the macropolyol include polyester polyol, polycaprolactone polyol, polyether polyol, polycarbonate polyol, acrylic polyol, and urethane-modified polyol, and preferably, polycarbonate polyol is used.

The polycarbonate polyol is obtained by a transesterification reaction of a dihydroxy component containing a dihydroxy compound containing a constituent unit derived from the dihydroxy compound represented by the formula (1) above, and if necessary, a dihydroxy compound containing a constituent unit derived from another dihydroxy compound, with carbonic acid diester (e.g., diphenyl carbonate).

This polycarbonate polyol has a heterocyclic ring, and contains a constituent unit derived from the dihydroxy compound represented by the formula (1) above as a component derived from plants. Therefore, the polycarbonate polyol has a heterocyclic ring and is derived from plants.

As described above, the dihydroxy compound represented by the formula (1) above is preferably isosorbide. Therefore, this polycarbonate polyol is preferably an isosorbide-modified polycarbonate polyol. That is, the heterocyclic ring-containing plant-derived polyol is preferably an isosorbide-modified polycarbonate polyol. When the heterocyclic ring-containing plant-derived polyol is an isosorbide-modified polycarbonate polyol, environmental load can be further reduced.

The heterocyclic ring-containing plant-derived polyols can be used alone or in combination of two or more.

The heterocyclic ring-containing plant-derived polyol has a degree of biomass of, for example, 10% or more, preferably 30% or more, more preferably 40% or more, and for example, 70% or less.

### [Hydroxyl Group-Containing Unsaturated Compound]

The hydroxyl group-containing unsaturated compound has both one or more ethylenically unsaturated groups and one or more hydroxyl groups in its molecule.

More specifically, the hydroxyl group-containing unsaturated compound has both one or more hydroxyl groups, and one or more ethylenically unsaturated group-containing groups of at least one selected from the group consisting of an acryloyl group, a methacryloyl group, a vinylphenyl group, a propenyl ether group, an allyl ether group, and a vinyl ether group.

For the ethylenically unsaturated group-containing group, preferably, an acryloyl group and/or a methacryloyl group is/are used, further preferably, an acryloyl group is used.

When the ethylenically unsaturated group-containing group is an acryloyl group and/or a methacryloyl group, for the hydroxyl group-containing unsaturated compound, for example, a hydroxyl group-containing (meth)acrylate is used.

The term “(meth)acryl” is defined as acryl and/or methacryl, and the term “(meth)acrylate” is defined as acrylate and/or methacrylate.

Examples of the hydroxyl group-containing (meth)acrylate include monohydroxyl mono(meth)acrylate having one hydroxyl group and having one acryloyl group or methacryloyl group in one molecule, polyhydroxyl mono(meth)acrylate having a plurality of hydroxyl groups and having one acryloyl group or methacryloyl group in one molecule, monohydroxyl poly(meth)acrylate having one hydroxyl group and having a plurality of acryloyl groups and/or methacryloyl groups in one molecule, and polyhydroxyl poly(meth)acrylate having a plurality of hydroxyl groups and having a plurality of acryloyl groups and/or methacryloyl groups in one molecule.

Examples of the monohydroxyl mono(meth)acrylate include 2-hydroxyethyl (meth)acrylate, 2-hydroxypropyl (meth)acrylate, 4-hydroxybutyl (meth)acrylate, 2-hydroxybutyl (meth)acrylate, 2-phenoxypropyl (meth)acrylate, 4-hydroxycyclohexyl (meth)acrylate, 3-chloro-2-hydroxypropyl (meth)acrylate, 2-hydroxy-3-phenyloxypropyl (meth)acrylate, 2-(meth)acryloyloxyethyl-2-hydroxyethyl phthalic acid, 2-hydroxyalkyl (meth)acryloyl phosphate, pentanediol mono(meth)acrylate, neopentyl glycol mono(meth)acrylate, polyethylene glycol mono(meth)acrylate, and polypropylene glycol mono(meth)acrylate.

Examples of the polyhydroxyl mono(meth)acrylate include trimethylolpropane mono(meth)acrylate, glycerin mono(meth)acrylate, and pentaerythritol mono(meth)acrylate.

Examples of the monohydroxyl poly(meth)acrylate include trimethylolpropane di(meth)acrylate, glycerin di(meth)acrylate, pentaerythritol tri(meth)acrylate, dipentaerythritol penta(meth)acrylate, and 2-hydroxy-3-(meth)acryloyloxypropyl (meth)acrylate (e.g., 2-hydroxy-3-acryloyloxypropyl methacrylate (trade name: NK Ester 701A, manufactured by Shin-Nakamura Chemical Co., Ltd.)).

Examples of the polyhydroxyl poly(meth)acrylate include pentaerythritol di(meth)acrylate, dipentaerythritol tri(meth)acrylate, and dipentaerythritol tetra(meth)acrylate.

When the ethylenically unsaturated group-containing group is a vinylphenyl group, the hydroxyl group-containing unsaturated compound includes, for example, 4-vinylphenol, 2-hydroxyethyl-4-vinyl phenyl ether, (2-hydroxypropyl)-4-vinyl phenyl ether, (2,3-dihydroxypropyl)-4-vinylphenylether, and 4-(2-hydroxyethyl)styrene.

When the ethylenically unsaturated group-containing group is a propenyl ether group, the hydroxyl group-containing unsaturated compound includes, for example, propenyl alcohol, 2-hydroxyethyl propenyl ether, and 2,3-dihydroxypropyl propenyl ether.

When the ethylenically unsaturated group-containing group is an allyl ether group, the hydroxyl group-containing unsaturated compound includes, for example, allyl alcohol, 2-hydroxyethyl allyl ether, and 2-hydroxypropyl allyl alcohol.

When the ethylenically unsaturated group-containing group is a vinyl ether group, the hydroxyl group-containing unsaturated compound includes, for example, 2-hydroxyethyl vinyl ether and 2-hydroxypropyl vinyl ether.

Of these hydroxyl group-containing unsaturated compounds, preferably, hydroxyl group-containing (meth)acrylate, more preferably, monohydroxyl mono(meth)acrylate, further preferably, 2-hydroxyethyl (meth)acrylate, particularly preferably, 2-hydroxyethyl acrylate is used.

The hydroxyl group-containing unsaturated compounds can be used alone or in combination of two or more.

To allow the polyisocyanate component to react with the hydroxyl component, the polyisocyanate component and the hydroxyl component (heterocyclic ring-containing plant-derived polyol and hydroxyl group-containing unsaturated compound) are mixed to react.

Specifically, first, the polyisocyanate component is allowed to react with the heterocyclic ring-containing plant-derived polyol.

More specifically, first, the polyisocyanate component is allowed to react with the heterocyclic ring-containing plant-derived polyol so that the isocyanate group (NCO) of the polyisocyanate component is excessive relative to the hydroxyl group (OH) of the heterocyclic ring-containing plant-derived polyol, thereby obtaining a prepolymer composition containing an isocyanate group-terminated prepolymer.

Specifically, the polyisocyanate component is allowed to react with the heterocyclic ring-containing plant-derived polyol so that an equivalent ratio (NCO/OH) of the polyisocyanate component to the heterocyclic ring-containing plant-derived polyol is, for example, 1.5 or more, preferably 2 or more, further preferably 3 or more, and for example, 20 or less, preferably 10 or less, further preferably 8 or less.

In the above-described reaction, the reaction temperature is, for example, 40° C. or more, preferably 50° C. or more, more preferably 60° C. or more, and for example, 120° C. or less, preferably 100° C. or less, more preferably 90° C. or less. The reaction time is, for example, 0.5 hours or more, preferably 1 hour or more, and for example, 10 hours, preferably 5 hours or less.

The above-described reaction is completed when a desired concentration (e.g., 1% by mass or more and 40% by mass or less) of the isocyanate group is obtained. The reaction is preferably carried out under a nitrogen atmosphere. At the same time, dry air is preferably bubbled into the reaction solution for the purpose of suppressing polymerization (self-polymerization) of the hydroxyl group-containing unsaturated compound.

In the above-described reaction, as necessary, a known organic solvent and a known urethanizing catalyst (e.g., amine catalyst, tin catalyst, lead catalyst, bismuth catalyst, zirconium catalyst, zinc catalyst) can be added at an appropriate ratio.

In this manner, a prepolymer composition can be obtained as a mixture of the isocyanate group-terminated prepolymer and an unreacted polyisocyanate.

In the above-described reaction, when an organic solvent is added, the prepolymer composition is prepared as an organic solvent solution in which the isocyanate group-terminated prepolymer is dissolved or dispersed in the organic solvent.

Then, if necessary, the unreacted polyisocyanate in the prepolymer composition is removed by, for example, distillation and extraction.

Then, the prepolymer composition is allowed to react with the hydroxyl group-containing unsaturated compound.

In this manner, the hydroxyl group-containing unsaturated compound can be bonded to a molecular terminal of the isocyanate group-terminated prepolymer, and the ethylenically unsaturated group can be contained in a molecular terminal of the urethane resin.

More specifically, the isocyanate group-terminated prepolymer and the unreacted polyisocyanate are allowed to react with the hydroxyl group-containing unsaturated compound so that an equivalent ratio (NCO/OH) of the isocyanate groups of the isocyanate group-terminated prepolymer and the unreacted polyisocyanate to the hydroxyl group (OH) of the hydroxyl group-containing unsaturated compound is, for example, 0.7 or more, preferably or more, more preferably 0.9 or more, and 1.3 or less, preferably 1.2 or less, more preferably 1.1 or less.

In the above-described reaction, the reaction temperature is, for example, 40° C. or more, preferably 60° C. or more, and for example, 100° C. or less, preferably 80° C. or less. The reaction time is, for example, 0.5 hours or more, and for example, 10 hours or less.

In the above-described reaction, as necessary, the reaction solvent and the urethanizing catalyst can be added at an appropriate ratio.

In the above-described reaction, in order to prevent polymerization (self-polymerization) of the hydroxyl group-containing unsaturated compound, a polymerization inhibitor can also be blended in an amount of 10 ppm or more, preferably 50 ppm or more, and for example, 10000 ppm or less, preferably 5000 ppm or less, with the reaction system.

Examples of the polymerization inhibitor include hydroquinone, methoxy phenol, methyl hydroquinone (also known as hydroquinone methyl ether), 2-tertiary butyl hydroquinone, p-benzoquinone, tertiary butyl p-benzoquinone, and phenothiazine.

In the above-described reaction, for example, monool can also be added.

Examples of the monool include methanol, ethanol, propanol, isopropyl alcohol, butanol, 1-methoxy-2-propanol, 2-ethylhexyl alcohol, other alkanol (C5 to 38) and aliphatic unsaturated alcohols (C9 to 24), alkenyl alcohol, 2-propene-1-ol, alkadienol (C6 to 8), and 3,7-dimethyl-1,6-octadiene-3-ol.

The monool is blended at a ratio such that the hydroxyl group is equal to the unreacted isocyanate group or exceeds 1, more specifically, for example, 1 or more, preferably 1.05 or more, and for example, 2 or less, preferably 1.5 or less.

The monool can also be blended after completion of the reaction between the prepolymer composition and the hydroxyl group-containing unsaturated compound, or can also be mixed with the hydroxyl group-containing unsaturated compound to react with the prepolymer composition.

Such blending of the monool allows the unreacted isocyanate group remaining at a predetermined concentration to disappear.

In this manner, for example, the urethane resin is obtained as a mixture of a main product composed of the isocyanate group-terminated prepolymer and the hydroxyl group-containing unsaturated compound and a by-product composed of the polyisocyanate and the hydroxyl group-containing unsaturated compound. The by-product can also be removed by, for example, distillation and extraction, if necessary.

In the urethane resin, the ethylenically unsaturated group may be contained in (in the middle of) a molecular chain or in a molecular terminal. The ethylenically unsaturated group is preferably contained in a molecular terminal of the urethane resin.

The position of the ethylenically unsaturated group in the molecule of the urethane resin is determined according to the molecular structure of the hydroxyl group-containing unsaturated compound.

When the prepolymer composition is prepared as an organic solvent solution, the urethane resin is prepared as an organic solvent solution in which the urethane resin is dissolved or dispersed in the organic solvent.

The urethane resin has a degree of biomass of, for example, 10% or more, preferably 40% or more, more preferably 45% or more, and for example, 70% or less.

### <Other Embodiments of Urethane Resin>

If necessary, the hydroxyl component can also contain other polyols other than the heterocyclic ring-containing plant-derived polyols and hydroxyl group-containing unsaturated compounds described above.

Examples of other polyols include macropolyols.

The blending amount of other polyols is not particularly limited, and is appropriately adjusted within a range in which the urethane resin has the above-described degree of biomass.

Other polyols can be used alone or in combination of two or more.

When the hydroxyl component contains other polyols, in order to allow the polyisocyanate component to react with the hydroxyl component, first, the polyisocyanate component is allowed to react with the heterocyclic ring-containing plant-derived polyol and other polyols to obtain a prepolymer composition containing the isocyanate group-terminated prepolymer, and then the prepolymer composition and the hydroxyl group-containing unsaturated compound are allowed to react.

The hydroxyl component preferably does not contain other polyols, and is composed of the heterocyclic ring-containing plant-derived polyol and the hydroxyl group-containing unsaturated compound.

### <Curable Polyurethane Resin Composition>

The curable polyurethane resin composition contains the above-described urethane resin.

The curable polyurethane resin composition can also contain a polyfunctional (meth)acrylate having three or more ethylenically unsaturated groups according to the purpose and application.

That is, the curable polyurethane resin composition containing the urethane resin but not containing a polyfunctional (meth)acrylate is first flowed, and the polyfunctional (meth)acrylate is then blended with this curable polyurethane resin composition in some cases. Alternatively, the curable polyurethane resin composition containing the urethane resin and the polyfunctional (meth)acrylate is flowed in some cases.

The polyfunctional (meth)acrylate is a compound that polymerizes by irradiation with an active energy ray (to be described later). The polyfunctional (meth)acrylate is a reactive diluent to be blended when the curable polyurethane resin composition has a high viscosity.

The polyfunctional (meth)acrylate contains three or more (meth)acryloyl group as an ethylenically unsaturated group.

Examples of the polyfunctional (meth)acrylate include tri(meth)acrylate, tetra(meth)acrylate, penta(meth)acrylate, and hexa(meth)acrylate. Examples of the tri(meth)acrylate include trimethylolpropane tri(meth)acrylate and pentaerythritol tri(meth)acrylate. Examples of the tetra(meth)acrylate include dimethylolpropane tetra(meth)acrylate and pentaerythritol tetra(meth)acrylate. Examples of the penta(meth)acrylate include dipentaerythritol penta(meth)acrylate. Examples of the hexa(meth)acrylate include dipentaerythritol hexa(meth)acrylate.

For the polyfunctional (meth)acrylate, preferably, penta(meth)acrylate and hexa(meth)acrylate are used, more preferably, pentaerythritol penta(meth)acrylate and dipentaerythritol hexa(meth)acrylate are used, further preferably, pentaerythritol pentaacrylate and dipentaerythritol hexaacrylate are used.

Urethane (meth)acrylate obtained by a reaction between the above-described polyfunctional (meth)acrylate and polyisocyanate is also included in the polyfunctional (meth)acrylate. Examples of the polyisocyanate include diisocyanates exemplified as the above-described polyisocyanate component. For the urethane (meth)acrylate, preferably, pentaerythritol triacrylate hexamethylene diisocyanate urethane prepolymer is used.

The polyfunctional (meth)acrylate is blended in an amount of, for example, 30 parts by mass or more, preferably 40 parts by mass or more, more preferably 50 parts by mass or more, further preferably 60 parts by mass or more, particularly preferably 70 parts by mass or more, most preferably 80 parts by mass or more, even more preferably 100 parts by mass or more, even more preferably 200 parts by mass or more, and for example, 400 parts by mass or less relative to 100 parts by mass of the urethane resin (reaction product of the above-described polyisocyanate component and the above-described hydroxyl component).

When the blending amount of the polyfunctional (meth)acrylate is the lower limit or more, the hardness of the cured product obtained by curing the curable polyurethane resin composition can be improved while cloudiness in the cured product is suppressed. In particular, when the blending amount of the polyfunctional (meth)acrylate is 60 parts by mass or more, cloudiness in the cured product can be suppressed even after an abrasion resistance test to be described later.

The polyfunctional (meth)acrylates can be used alone or in combination of two or more. Preferably, pentaerythritol triacrylate hexamethylene diisocyanate urethane prepolymer is used alone, and pentaerythritol pentaacrylate and dipentaerythritol hexaacrylate are used in combination.

When containing a polyfunctional (meth)acrylate having three or more ethylenically unsaturated groups, the curable polyurethane resin composition, if necessary, contains a known photopolymerization initiator at an appropriate ratio.

According to the purpose and application, various additives such as a sensitizer, as necessary, a photopolymerization accelerator, an antifoaming agent, a leveling agent, a pigment, a dye, a silicon compound, rosins, a silane coupling agent, an antioxidant, a colorant, or a brightener can also be added to the curable polyurethane resin composition at an appropriate ratio.

The curable polyurethane resin composition has a degree of biomass of, for example, 10% or more, preferably 30% or more, more preferably 40% or more, and for example, 70% or less.

### <Operations and Effects>

The curable polyurethane resin composition contains a plant-derived polyol (heterocyclic ring-containing plant-derived polyol). Therefore, environmental load can be reduced.

In addition, the curable polyurethane resin composition contains a polyol containing a heterocyclic structure (heterocyclic ring-containing plant-derived polyol). Therefore, cloudiness in the cured product obtained by curing the curable polyurethane resin composition can be suppressed.

In particular, when the curable polyurethane resin composition contains the above-described polyfunctional (meth)acrylate at a predetermined ratio, cloudiness in the cured product can be suppressed.

More specifically, when a polyol having a carbocyclic ring structure is used, compatibility with the polyfunctional (meth)acrylate is reduced, which makes it impossible to suppress cloudiness in the cured product in some cases.

On the other hand, the curable polyurethane resin composition uses a polyol containing a heterocyclic structure (heterocyclic ring-containing plant-derived polyol). Therefore, electrostatic repulsion occurs between unpaired electrons on a heteroatom. In this manner, it is deduced that overlap between the cyclic structures becomes weak as compared with the carbocyclic ring composed only of carbon atoms. It is also deduced that since the overlap between the cyclic structures becomes weak as compared with the carbocyclic ring, the compatibility with the polyfunctional (meth)acrylate is thus improved.

The ester group of the polyfunctional (meth)acrylate has a polarity derived from carbon-oxygen bonds. On the other hand, it is deduced that since the heterocyclic ring containing elements other than carbon has higher polarity than the carbocyclic ring composed of only carbon atoms, the compatibility with the polyfunctional (meth)acrylate is improved.

The curable polyurethane resin composition can be used as a coating material, ink, pressure-sensitive adhesive, adhesive, sealing agent, elastomer, aqueous resin, thermosetting resin, microcapsule, dental material, lens, binder resin, waterproofing material, film, sheet, and stereolithographic resin used in a 3D printer or the like. It can also be used as a piezoelectric material or a pyroelectric material used in a speaker, sensors, and a power generation device (a device for converting heat or mechanical stimulation into electric energy).

For example, the coating material can be used in various industrial products such as plastic films, plastic sheets, plastic foams, lenses for glasses, frames for glasses, fiber, artificial leather, synthetic leather, metal, and woods.

More specifically, the plastic film coating can be used in optical members (e.g., optical films, optical sheets, etc.), optical coating materials, fiber, electric and electronic materials, food packaging, cosmetic packaging, decorative films, and protective sheets for solar cell modules.

The pressure-sensitive adhesive and the adhesive can be used in display devices such as liquid crystal display (LCD), EL (electroluminescence) display, EL illumination, electronic paper, and plasma display; and information recording medium of optical disk (specifically, Blu-ray disc, DVD (digital video (or versatile) disc), MO (magneto-optical disc), and PD (phase-change optical disc), etc.).

The ink can be used in flexographic printing, dry offset printing; letterpress printing; intaglio printing such as gravure printing and gravure offset printing; planographic printing such as offset printing; mimeographic printing such as screen printing; and inkjet printing (printing method in which printing is performed by jetting droplets of ink composition to adhere the droplets on a recording medium such as paper).

### <Cured Product>

A cured product can be obtained by curing the curable polyurethane resin composition.

To cure the curable polyurethane resin composition, an active energy ray is irradiated to the curable polyurethane resin composition.

Examples of the active energy ray include ultraviolet rays and electron beams. The dose of the active energy ray is, for example, 50 mJ/cm² or more, preferably 100 mJ/cm² or more, and for example, 5000 mJ/cm² or less, preferably 1000 mJ/cm² or less.

In this manner, a cured product is obtained. Such a cured product is obtained by curing the curable polyurethane resin composition. Therefore, cloudiness is suppressed while environmental load is reduced.

Specifically, the cured product has a haze of, for example, less than 0.5%, preferably, 0.4% or less.

A method for measuring the haze of the cured product is described in detail in Example to be described later.

The cured product obtained by curing the curable polyurethane resin composition can be suitably used in applications which particularly require transparency because cloudiness therein is suppressed.

As an example of the method for using the curable polyurethane resin composition, the following describes in detail a case of coating a surface of an object to be coated 2 (to be described later) with the curable polyurethane resin composition.

### <Method for Using Curable Polyurethane Resin Composition (Method for Producing a Laminate)>

The curable polyurethane resin composition is used to coat the surface of the object to be coated 2. By coating the object to be coated 2, a laminate 1 is produced.

The method for producing the laminate 1 includes a first step of preparing the object to be coated 2; and a second step of disposing a cured film 3 by applying the curable polyurethane resin composition and curing the applied composition.

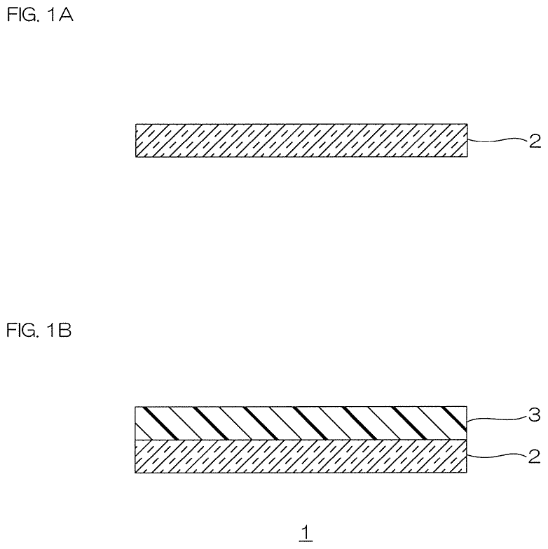

With reference to FIG. 1, one embodiment of the method for producing the laminate 1 is described.

In FIG. 1, the up-down direction on the plane of the sheet is referred to as an up-down direction (thickness direction), the upper side on the plane of the sheet is referred to as an upper side (one side in the thickness direction), and the lower side on the plane of the sheet is referred to as a lower side (the other side in the thickness direction). The right-left direction and the depth direction on the plane of the sheet is a plane direction orthogonal to the up-down direction. Specifically, these directions conform to the directional arrows in the drawings.

In the first step, as shown in FIG. 1A, the object to be coated 2 is prepared.

The object to be coated 2 is an object to be coated of which various properties are imparted to a surface (one surface in the thickness direction) by the cured film 3.

In FIG. 1A, the object to be coated 2 has a flat plate shape, but the shape thereof is not particularly limited, and various shapes may be selected.

The object to be coated 2 is not particularly limited, and examples thereof include resin and metal.

In the second step, as shown in FIG. 1B, first, the curable polyurethane resin composition is applied to the surface (one surface in the thickness direction) of the object to be coated 2, and if necessary, is dried to thereby form a coated film.

Then, the coated film is cured. To cure the coated film, an active energy ray is irradiated to the coated film.

In this manner, the surface (one surface in the thickness direction) of the object to be coated 2 is disposed on the cured film 3 to give the laminate 1.

This laminate 1 includes the object to be coated 2, and the cured film 3 made of the cured product of the curable polyurethane resin composition in this order in the thickness direction.

Since the laminate 1 includes the cured film 3 made of the cured product of the curable polyurethane resin composition, it can suppress cloudiness in the cured product 3 while reducing environmental load.

### EXAMPLES

Next, the present invention is described with reference to Examples and Comparative Examples. The present invention is however not limited by the following Examples. The “parts” and “%” are based on mass unless otherwise specified. The specific numerical values in blending ratio (content ratio), property value, and parameter used in the following description can be replaced with upper limit values (numerical values defined as “or less” or “below”) or lower limit values (numerical values defined as “or more” or “above”) of corresponding numerical values in blending ratio (content ratio), property value, and parameter described in the above-described “DESCRIPTION OF THE EMBODIMENTS”.

### 1. Details of Components

Trade names and abbreviations of the components used in Production Examples, Examples, and Comparative Examples are described in detail.
1,5-PDI: 1,5-pentamethylene diisocyanate, degree of biomass 70% according to ASTM D6866, trade name “STABiO PDI”, manufactured by Mitsui Chemicals, Inc.
PDI nurate: Isocyanurate derivative of 1,5-pentamethylene diisocyanate, degree of biomass 70% according to ASTM D6866, trade name “STABiO D-370N”, manufactured by Mitsui Chemicals, Inc.
1,6-HDI: 1,6-hexamethylene diisocyanate
HS0850H: Polycarbonate polyol (derived from plants) containing a constituent unit derived from the dihydroxy compound represented by the formula (1) above, hydroxyl value 141.3 mgKOH/g, degree of biomass 44% according to ASTM D6866, trade name “BENEBiOL HS0850H”, manufactured by Mitsubishi Chemical Corporation
NL1010DB: Polycarbonate polyol without a ring or cyclic structure, hydroxyl value 113.5 mgKOH/g, degree of biomass 22% according to ASTM D6866, trade name “BENEBiOL NL1010DB”, manufactured by Mitsubishi Chemical Corporation
UM-90(1/1): Polycarbonate polyol having a carbocyclic ring, hydroxyl value 126.0 mgKOH/g, degree of biomass 0% according to ASTM D6866, trade name “ETERNACOLL UM-90(1/1)”, manufactured by Ube Industries Ltd.
UC-100: Polycarbonate polyol having a carbocyclic ring, hydroxyl value 116.1 mgKOH/g, degree of biomass 0% according to ASTM D6866, trade name “ETERNACOLL UC-100”, manufactured by Ube Industries Ltd.
HEA: 2-hydroxyethyl acrylate, manufactured by FUJIFILM Wako Pure Chemical Corporation (first class grade reagent)
ARONIX M402: Mixture of dipentaerythritol pentaacrylate and dipentaerythritol hexaacrylate, trade name “ARONIX M402”, manufactured by Toagosei Co., Ltd.
UA-306H: Pentaerythritol triacrylate hexamethylene diisocyanate urethane prepolymer, manufactured by Kyoeisha Chemical Co., Ltd.
NEOSTANN U810: Tin-based curing catalyst, manufactured by Nitto Kasei Co., Ltd.

### 2. Synthesis of Urethane Resin

### Synthesis Example 1

To a dry flask were added 297.8 g of HS0850H, 297.8 g of ethyl acetate, and 0.12 g of NEOSTANN U810, mixed and stirred at 45° C. to give a uniform solution.

Then, as a polyisocyanate component, 69.38 g of 1,5-PDI and 17.01 g of PDI nurate were added thereto dividedly 3 times and the mixture was heated to 70° C.

Then, the polyisocyanate component and HS0850H were allowed to react at 70° C. for 1.5 hours. Thereafter, 29.03 g of HEA, 65.60 g of methyl ethyl ketone, and 0.08 g of methyl hydroquinone (Tokyo Chemical Industry Co., Ltd., first class grade reagent) were added thereto, and the mixture was allowed to react for one hour while dry air was gently bubbled.

Then, 20.00 g of 1-methoxy-2-propanol was added thereto, and the mixture was stirred at 70° C. for 20 minutes. Thereafter, the obtained mixture was filtered to give a urethane resin (solids concentration 50.0%, degree of biomass 46.5%).

### Synthesis Examples 2 to 7

According to the same procedure as in Synthesis Example 1, a urethane resin was obtained. The blending formulation was changed in accordance with Table 1.

### 3. Preparation of Curable Polyurethane Resin Composition

### Examples 1 to 3 and Comparative Examples 1 to 4

According to the blending formulation in Tables 2 and 3, the urethane resin (solids concentration 50.0% by mass), 10.45 g of dimethyl carbonate, 10.45 g of ethyl acetate, and 0.30 g of Irgacure 1173 (manufactured by BASF Japan Ltd.) as a photopolymerization initiator were mixed to prepare a uniform curable polyurethane resin composition (solids concentration 25% by mass).

### Examples 4 to 8, 10 to 16, and 18

According to the blending formulation in Tables 2 and 3, the urethane resin (solids concentration 50.0% by mass), ARONIX M402 or UA-306H, 3 parts by mass of Irgacure 1173 relative to the total mass of the resin, and a liquid mixture of dimethyl carbonate and ethyl acetate (dimethyl carbonate:ethyl acetate=1:1 (mass ratio)) were mixed to prepare a uniform curable polyurethane resin composition (solids concentration 25% by mass).

### Examples 9 and 17

According to the blending formulation in Tables 2 and 3, the urethane resin (solids concentration 50.0% by mass), 8.00 g of ARONIX M402, 22.95 g of dimethyl carbonate, 22.95 g of ethyl acetate, 0.09 g of BYK333 (manufactured by Shin-Etsu Chemical Co., Ltd.) as a leveling agent, and 0.54 g of Irgacure 1173 were mixed to prepare a uniform curable polyurethane resin composition (solids concentration 25% by mass).

### 4. Evaluation

### <Degree of Biomass>

The degree of biomass was calculated based on the following formula (2):

Sum total of (degree of biomass×carbon content×amount used) of biomass raw materials/sum total of (carbon content×amount used) of all raw materials (2)

In the formula (2) above, the degree of biomass of each raw material was determined according to American Society for Testing and Materials (ASTM D6866).

As for monomers/oligomers of which structures were clear, the carbon content was calculated using the values calculated from molecular formulas thereof, and as for those of which structures were unclear, the carbon content was calculated by elemental analysis thereof.

All the raw materials were organic solvent-free.

### <Evaluation of Haze>

Using an applicator 0.101 mm (model YA-4, manufactured by Yoshimitsu Seiki Co., Ltd.), one surface in the thickness direction of a polycarbonate resin substrate (trade name “PC 1600”, 150 mm×70 mm×2.0 mm in thickness, manufactured by C. I. TAKIRON Corporation) as an object to be coated was coated with each of the curable polyurethane resin compositions of Examples and Comparative Examples, and the solvent was evaporated by drying at 70° C. for 2 minutes with a warm-air dryer, to thereby form a coated film on one surface in the thickness direction of the polycarbonate resin substrate.

Then, the coated film was irradiated with ultraviolet rays (electrodeless H-bulb 240 W/cm², output 100%, lamp height 70 mm, conveyor speed 8.9 m/min, integrated light intensity 400 mJ/cm², measured by UV Power Puck II manufactured by Electronic Instrumentation & Technology, Inc.) by allowing the polycarbonate resin substrate to pass through once in a conveyor of an ultraviolet irradiation device, to thereby cure the coated film.

This gave a cured film, and therefore, a laminate including the object to be coated and the cured film on one surface in the thickness direction in this order was obtained.

Then, the haze of the cured film immediately after curing was measured using a haze meter (NDH-4000, manufactured by Nippon Denshoku Industries Co., Ltd.). The results are shown in Tables 2 and 3.

Separately, the cured film was subjected to an abrasion resistance test. Specifically, using a Gakushin-type rubbing tester (rubbing tester II, manufactured by Yasuda Seiki Seisakusho Ltd.), the cured film was rubbed back and forth 50 times with a steel wool (BONSTAR #0000, manufactured by Nihon Steel Wool Co., Ltd.) under a load of 500 g. The haze was measured after the abrasion resistance test. The results are shown in Tables 2 and 3.

In the haze measurement, the test was performed twice and their test results were averaged to give a value.

### 5. Discussion

### <Urethane Resin of Synthesis Example 1 (Polyisocyanate Component: 1,5-PDI and PDI Nurate, Hydroxyl Component: Heterocyclic Ring-Containing Polyol)>

In Examples 1, and 4 to 9, the urethane resin of Synthesis Example 1 is used.

In Example 1, a polyfunctional (meth)acrylate is not contained, and in Examples 4 to 9, a polyfunctional (meth)acrylate is contained.

In Example 1, in the haze test, the cured film immediately after curing has a haze of less than 0.5%. This shows that cloudiness in the cured film can be suppressed.

In Examples 4 to 9, in the haze test, the cured film immediately after curing has a haze of less than 0.5%. This shows that cloudiness in the cured film can be suppressed even though the curable polyurethane resin composition contains a polyfunctional (meth)acrylate.

### <Urethane Resin of Synthesis Example 2 (Polyisocyanate Component: 1,5-PDI, Hydroxyl Component: Heterocyclic Ring-Containing Polyol)>

In Examples 2, and 10 to 17, the urethane resin of Synthesis Example 2 is used.

In Example 2, the curable polyurethane resin composition does not contain a polyfunctional (meth)acrylate, and in Examples 10 to 17, it contains a polyfunctional (meth)acrylate.

It can be seen that in Example 2, in the same manner as in Example 1 above, cloudiness in the cured film can be suppressed.

It can be seen that in Examples 10 to 17, in the same manner as in Examples 4 to 9 above, cloudiness in the cured film can be suppressed even though the curable polyurethane resin composition contains a polyfunctional (meth)acrylate.

### <Urethane Resin of Synthesis Example 6 (Polyisocyanate Component: 1,6-HDI, Hydroxyl Component: Heterocyclic Ring-Containing Polyol)>

In Examples 3 and 18, the urethane resin of Synthesis Example 6 is used.

In Example 3, the curable polyurethane resin composition does not contain a polyfunctional (meth)acrylate, and in Example 18, it contains a polyfunctional (meth)acrylate.

It can be seen that in Example 3, in the same manner as in Example 1 above, cloudiness in the cured film can be suppressed.

It can be seen that in Example 18, in the same manner as in Examples 4 to 9 above, cloudiness in the cured film can be suppressed even though the curable polyurethane resin composition contains a polyfunctional (meth)acrylate.

<Urethane Resin of Synthesis Example 3 (Polyisocyanate Component: 1,5-PDI, Hydroxyl Component: Polycarbonate Polyol without a Ring or Cyclic Structure)>

In Comparative Examples 1, 5 and 6, the urethane resin of Synthesis Example 3 is used.

In Comparative Example 1, the curable polyurethane resin composition does not contain a polyfunctional (meth)acrylate, and in Comparative Examples 5 and 6, it contains a polyfunctional (meth)acrylate.

In Comparative Example 1, in the haze test, the cured film immediately after curing has a haze exceeding 0.5%. This shows that cloudiness in the cured film cannot be suppressed.

In Comparative Examples 5 and 6, the cured film immediately after curing has a haze exceeding 0.5%. This shows that cloudiness in the cured film cannot be suppressed even though the curable polyurethane resin composition contains a polyfunctional (meth)acrylate.

### <Urethane Resin of Synthesis Example 4 (Polyisocyanate Component: 1,5-PDI, Hydroxyl Component: Polycarbonate Polyol Having a Carbocyclic Ring)>

In Comparative Examples 2, 7 and 8, the urethane resin of Synthesis Example 4 is used.

In Comparative Example 2, the curable polyurethane resin composition does not contain a polyfunctional (meth)acrylate, and in Comparative Examples 7 and 8, it contains a polyfunctional (meth)acrylate.

It can be seen that in Comparative Example 2, in the same manner as in Comparative Example 1 above, cloudiness in the cured film cannot be suppressed.

Further, it can be seen that in Comparative Examples 7 and 8, in the same manner as in Comparative Examples 5 and 6 above, cloudiness in the cured film cannot be suppressed even though the curable polyurethane resin composition contains a polyfunctional (meth)acrylate.

### <Urethane Resin of Synthesis Example 5 (Polyisocyanate Component: 1,5-PDI, Hydroxyl Component: Polycarbonate Polyol Having a Carbocyclic Ring)>

In Comparative Examples 3, 9 and 10, the urethane resin of Synthesis Example 5 is used.

In Comparative Example 3, the curable polyurethane resin composition does not contain a polyfunctional (meth)acrylate, and in Comparative Examples 9 and 10, it contains a polyfunctional (meth)acrylate.

In Comparative Example 3, in the haze test, the cured film immediately after curing has a haze of less than 0.5%, while having a haze exceeding 0.5% in Comparative Examples 9 and 10. This shows that when a polyfunctional (meth)acrylate is blended with the curable polyurethane resin composition of Comparative Example 3, cloudiness in the cured film cannot be suppressed.

### <Urethane Resin of Synthesis Example 7 (Polyisocyanate Component: 1,6-HDI, Hydroxyl Component: Polycarbonate Polyol Having a Carbocyclic Ring)>

In Comparative Examples 4, 11 and 12, the urethane resin of Synthesis Example 7 is used.

In Comparative Example 4, the curable polyurethane resin composition does not contain a polyfunctional (meth)acrylate, and in Comparative Examples 11 and 12, it contains a polyfunctional (meth)acrylate.

It can be seen that in Comparative Examples 4, 11, and 12, in the same manner as in Comparative Examples 3, 9, and 10 above, when a polyfunctional (meth)acrylate is blended with the curable polyurethane resin composition of Comparative Example 4, cloudiness in the cured film cannot be suppressed.

### <Degree of Biomass>

In Examples 1 to 18, a plant-derived polyol (heterocyclic ring-containing plant-derived polyol) is used.

The degrees of biomass in Examples 1 to 18 are 10 or more. Therefore, it can be seen that environmental load can be reduced. In particular, in Examples 3 and 18, plant-derived 1,5-PDI is not contained but 1,6-HDI is contained. However, since the hydroxyl component contains a plant-derived polyol (heterocyclic ring-containing plant-derived polyol), the degree of biomass can be improved.

TABLE 1

| | | | | Synthesis | Synthesis | Synthesis | Synthesis | Synthesis | Synthesis | Synthesis |
|---|---|---|---|---|---|---|---|---|---|---|
| Synthesis Example No. | | | | Example 1 | Example 2 | Example 3 | Example 4 | Example 5 | Example 6 | Example 7 |
| Blending | Polyisocyanate | 1,5-PDI | | 69.38 | 77.08 | 77.08 | 77.08 | 77.08 | | |
| formulation | component | PDI nurate | | 17.01 | | | | | | |
| (g) | | 1,6-HDI | | | | | | | 84.10 | 84.10 |
| | Hydroxyl | Heterocyclic ring- | HS0850H | 297.8 | 297.8 | | | | 297.8 | |
| | component | containing plant- | NL1010DB* | | | 370.8 | | | | |
| | | derived polyol | UM-90(1/1)* | | | | 334.0 | | | |
| | | | UC-100* | | | | | 362.5 | | 362.5 |
| | | Hydroxyl group- | HEA | 29.03 | 29.03 | 29.03 | 29.03 | 29.03 | 29.03 | 29.03 |
| | | containing | | | | | | | | |
| | | unsaturated | | | | | | | | |
| | | compound | | | | | | | | |

| | | | | | | | |
|---|---|---|---|---|---|---|---|
| Ethyl acetate | 297.8 | 297.8 | 370.8 | 334.0 | 362.5 | 297.8 | 362.5 |
| NEOSTANN U810 | 0.12 | 0.11 | 0.13 | 0.12 | 0.13 | 0.11 | 0.13 |
| Methyl ethyl ketone | 65.60 | 66.00 | 86.00 | 71.30 | 86.30 | 73.02 | 93.32 |
| Methyl hydroquinone | 0.08 | 0.07 | 0.09 | 0.08 | 0.09 | 0.07 | 0.09 |
| 1-Methoxy-2-propanol | 20.00 | 20.00 | 20.50 | 20.00 | 20.00 | 20.00 | 20.00 |

| | | | | | | | |
|---|---|---|---|---|---|---|---|
| Solids concentration (mass %) | 50.0 | 50.0 | 50.0 | 50.0 | 50.0 | 50.0 | 50.0 |
| Degree of biomass (%) | 46.5 | 46.0 | 28.5 | 12.2 | 11.5 | 46.0 | 11.5 |

*A heterocyclic ring is not contained.

TABLE 2

| | | Hydroxyl component | | | | | |
|---|---|---|---|---|---|---|---|
| | | Heterocyclic | | | | | |
| | | ring- | Hydroxyl | | | | |
| | | containing | group- | | | | |
| Ex. & | | plant- | containing | Urethane resin | | Polyfunctional (meth)acrylate | |
| Comp. | Polyisocyanate | derived | unsaturated | | Mass | | Mass |
| Ex. No. | component | polyol | compound | Resin | (g) | Brand | (g) |
| Ex. 1 | 1,5-PDI + | HS0850H | HEA | Synthesis | 20.00 | | |
| | PDI nurate | | | Example 1 | | | |
| Ex. 4 | 1,5-PDI + | HS0850H | HEA | Synthesis | 20.00 | ARONIX | 6.00 |
| | PDI nurate | | | Example 1 | | M402 | |
| Ex. 5 | 1,5-PDI + | HS0850H | HEA | Synthesis | 20.00 | ARONIX | 8.00 |
| | PDI nurate | | | Example 1 | | M402 | |
| Ex. 6 | 1,5-PDI + | HS0850H | HEA | Synthesis | 20.00 | ARONIX | 20.98 |
| | PDI nurate | | | Example 1 | | M402 | |
| Ex. 7 | 1,5-PDI + | HS0850H | HEA | Synthesis | 20.00 | ARONIX | 36.49 |
| | PDI nurate | | | Example 1 | | M402 | |
| Ex. 8 | 1,5-PDI + | HS0850H | HEA | Synthesis | 20.00 | UA-306H | 36.49 |
| | PDI nurate | | | Example 1 | | | |
| Ex. 9 | 1,5-PDI + | HS0850H | HEA | Synthesis | 20.00 | ARONIX | 8.00 |
| | PDI nurate | | | Example 1 | | M402 | |
| Ex. 2 | 1,5-PDI | HS0850H | HEA | Synthesis | 20.00 | | |
| | | | | Example 2 | | | |
| Ex. 10 | 1,5-PDI | HS0850H | HEA | Synthesis | 20.00 | ARONIX | 3.00 |
| | | | | Example 2 | | M402 | |
| Ex. 11 | 1,5-PDI | HS0850H | HEA | Synthesis | 20.00 | ARONIX | 4.00 |
| | | | | Example 2 | | M402 | |
| Ex. 12 | 1,5-PDI | HS0850H | HEA | Synthesis | 20.00 | ARONIX | 6.00 |
| | | | | Example 2 | | M402 | |
| Ex. 13 | 1,5-PDI | HS0850H | HEA | Synthesis | 20.00 | ARONIX | 8.00 |
| | | | | Example 2 | | M402 | |
| Ex. 14 | 1,5-PDI | HS0850H | HEA | Synthesis | 20.00 | ARONIX | 20.63 |
| | | | | Example 2 | | M402 | |
| Ex. 15 | 1,5-PDI | HS0850H | HEA | Synthesis | 20.00 | ARONIX | 35.96 |
| | | | | Example 2 | | M402 | |
| Ex. 16 | 1,5-PDI | HS0850H | HEA | Synthesis | 20.00 | UA-306H | 35.96 |
| | | | | Example 2 | | | |
| Ex. 17 | 1,5-PDI | HS0850H | HEA | Synthesis | 20.00 | ARONIX | 8.00 |
| | | | | Example 2 | | M402 | |

| | Polyfunctional | | | | | |
|---|---|---|---|---|---|---|
| | (meth)acrylate | | | | | |
| | Ratio | | | | | |
| | relative | | | | | |
| | to 100 | | | | | |
| | parts by | | | | | |
| | mass of | | | | | |
| | urethane | | | | Haze (%) | |
| | resin | | | | | After |
| Ex. & | Weight | Additive | | Degree of | Immediately | abrasion |
| Comp. | (pts. | | Mass | biomass | after | resistance |
| Ex. No. | mass) | Brand | (g) | (%) | curing | test |
| Ex. 1 | | | | 46.5 | 0.3 | 9.4 |
| Ex. 4 | 60 | | | 29.1 | 0.4 | 7.9 |
| Ex. 5 | 80 | | | 25.8 | 0.4 | 7.2 |
| Ex. 6 | 210 | | | 15.0 | 0.1 | 2.6 |
| Ex. 7 | 365 | | | 10.0 | 0.4 | 3.4 |
| Ex. 8 | 365 | | | 10.0 | 0.2 | 2.2 |
| Ex. 9 | 80 | BYK333 | 0.09 | 25.7 | 0.2 | 3.3 |
| Ex. 2 | | | | 46.0 | 0.3 | 10.1 |
| Ex. 10 | 30 | | | 35.4 | 0.4 | 12.5 |
| Ex. 11 | 40 | | | 32.8 | 0.4 | 11.3 |
| Ex. 12 | 50 | | | 28.7 | 0.2 | 9.6 |
| Ex. 13 | 80 | | | 25.5 | 0.1 | 6.6 |
| Ex. 14 | 206 | | | 15.0 | 0.1 | 5.9 |
| Ex. 15 | 360 | | | 10.0 | 0.2 | 3.0 |
| Ex. 16 | 360 | | | 10.0 | 0.3 | 2.4 |
| Ex. 17 | 80 | BYK333 | 0.09 | 25.4 | 0.1 | 2.6 |

TABLE 3

| | | Hydroxyl component | | | | | |
|---|---|---|---|---|---|---|---|
| | | Heterocyclic | | | | | |
| | | ring- | Hydroxyl | | | | |
| | | containing | group- | | | | |
| Ex. & | | plant- | containing | Urethane resin | | Polyfunctional (meth)acrylate | |
| Comp. | Polyisocyanate | derived | unsaturated | | Mass | | Mass |
| Ex. No. | component | polyol | compound | Resin | (g) | Brand | (g) |
| Comp. | 1,5-PDI | NL1010DB* | HEA | Synthesis | 20.00 | | |
| Ex. 1 | | | | Example 3 | | | |
| Comp. | 1,5-PDI | NL1010DB* | HEA | Synthesis | 20.00 | ARONIX | 18.45 |
| Ex. 5 | | | | Example 3 | | M402 | |
| Comp. | 1,5-PDI | NL1010DB* | HEA | Synthesis | 20.00 | UA-306H | 18.45 |
| Ex. 6 | | | | Example 3 | | | |
| Comp. | 1,5-PDI | UM-90(1/1)* | HEA | Synthesis | 20.00 | | |
| Ex. 2 | | | | Example 4 | | | |
| Comp. | 1,5-PDI | UM-90(1/1)* | HEA | Synthesis | 20.00 | ARONIX | 2.21 |
| Ex. 7 | | | | Example 4 | | M402 | |
| Comp. | 1,5-PDI | UM-90(1/1)* | HEA | Synthesis | 20.00 | UA-306H | 2.21 |
| Ex. 8 | | | | Example 4 | | | |
| Comp. | 1,5-PDI | UC-100* | HEA | Synthesis | 20.00 | | |
| Ex. 3 | | | | Example S | | | |
| Comp. | 1,5-PDI | UC-100* | HEA | Synthesis | 20.00 | ARONIX | 1.47 |
| Ex. 9 | | | | Example 5 | | M402 | |
| Comp. | 1,5-PDI | UC-100* | HEA | Synthesis | 20.00 | UA-306H | 1.47 |
| Ex. 10 | | | | Example 5 | | | |
| Ex. 3 | 1,6-HDI | HS0850H | HEA | Synthesis | 20.00 | | |
| | | | | Example 6 | | | |
| Ex. 18 | 1,6-HDI | HS0850H | HEA | Synthesis | 20.00 | ARONIX | 6.00 |
| | | | | Example 6 | | M402 | |
| Comp. | 1,6-HDI | UC-100* | HEA | Synthesis | 20.00 | | |
| Ex. 4 | | | | Example 7 | | | |
| Comp. | 1,6-HDI | UC-100* | HEA | Synthesis | 20.00 | ARONIX | 1.47 |
| Ex. 11 | | | | Example 7 | | M402 | |
| Comp. | 1,6-HDI | UC-100* | HEA | Synthesis | 20.00 | UA-306H | 1.47 |
| Ex. 12 | | | | Example 7 | | | |

| | Polyfunctional | | | | | |
|---|---|---|---|---|---|---|
| | (meth)acrylate | | | | | |
| | Ratio | | | | | |
| | relative | | | | | |
| | to 100 | | | | | |
| | parts by | | | | | |
| | mass of | | | | | |
| | urethane | | | | Haze (%) | |
| | resin | | | | | After |
| Ex. & | Weight | Additive | | Degree of | Immediately | abrasion |
| Comp. | (pts. | | Mass | biomass | after | resistance |
| Ex. No. | mass) | Brand | (g) | (%) | curing | test |
| Comp. | | | | 28.5 | 3.7 | 36.3 |
| Ex. 1 | | | | | | |
| Comp. | 185 | | | 10.0 | 0.7 | 7.2 |
| Ex. 5 | | | | | | |
| Comp. | 185 | | | 10.0 | 1.1 | 8.0 |
| Ex. 6 | | | | | | |
| Comp. | | | | 12.2 | 0.6 | 5.0 |
| Ex. 2 | | | | | | |
| Comp. | 22 | | | 10.0 | 3.9 | 5.3 |
| Ex. 7 | | | | | | |
| Comp. | 22 | | | 10.0 | 3.6 | 5.3 |
| Ex. 8 | | | | | | |
| Comp. | | | | 11.5 | 0.2 | 2.9 |
| Ex. 3 | | | | | | |
| Comp. | 15 | | | 10.0 | 3.2 | 5.7 |
| Ex. 9 | | | | | | |
| Comp. | 15 | | | 10.0 | 1.4 | 5.7 |
| Ex. 10 | | | | | | |
| Ex. 3 | | | | 31.8 | 0.3 | 9.8 |
| Ex. 18 | 60 | | | 19.9 | 0.3 | 8.2 |
| Comp. | | | | 0.0 | 0.3 | 3.5 |
| Ex. 4 | | | | | | |
| Comp. | 15 | | | 0.0 | 2.9 | 6.9 |
| Ex. 11 | | | | | | |
| Comp. | 15 | | | 0.0 | 1.4 | 6.7 |
| Ex. 12 | | | | | | |

While the illustrative embodiments of the present invention are provided in the above-described invention, such is for illustrative purpose only and it is not to be construed restrictively. Modification and variation of the present invention that will be obvious to those skilled in the art is to be covered by the following claims.

### INDUSTRIAL APPLICABILITY

The curable polyurethane resin composition, cured product, and laminate according to the present invention can be suitably used in various industrial products such as plastic films, plastic sheets, plastic foams, lenses for glasses, frames for glasses, fiber, artificial leather, synthetic leather, metal, and woods.

### DESCRIPTION OF REFERENCE NUMERALS

1 laminate
2 object to be coated
3 cured film

1. A curable polyurethane resin composition comprising a reaction product of
a polyisocyanate component comprising an aliphatic diisocyanate and/or a derivative thereof, and
a hydroxyl component comprising a heterocyclic ring-containing plant-derived polyol that contains a heterocyclic structure and is derived from plants; and a hydroxyl group-containing unsaturated compound containing an ethylenically unsaturated group and a hydroxyl group.

2. The curable polyurethane resin composition according to claim 1, wherein the aliphatic diisocyanate comprises plant-derived 1,5-pentamethylene diisocyanate.

3. The curable polyurethane resin composition according to claim 1, wherein the heterocyclic ring-containing plant-derived polyol is an isosorbide-modified polycarbonate polyol.

4. The curable polyurethane resin composition according to claim 1, further comprising a polyfunctional (meth)acrylate having three or more ethylenically unsaturated groups,
wherein the polyfunctional (meth)acrylate is contained in an amount of 30 parts by mass or more relative to 100 parts by mass of the reaction product.

5. A cured product of the curable polyurethane resin composition as defined in claim 1.

6. The cured product according to claim 5, having a haze of less than 0.5%.

7. A laminate, comprising an object to be coated; and a cured film made of the cured product as defined in claim 5 in a thickness direction.
